(19) United States
(12) Patent Application Publication
(10) Pub. No.: US 2018/0203816 A1
(43) Pub. Date: Jul. 19, 2018

(54) SYSTEM INCLUDING HOT PLUG MODULE AND MEMORY MODULE

(71) Applicant: SK hynix Inc., Icheon-si Gyeonggi-do (KR)

(72) Inventor: Young Choul CHO, Icheon-si Gyeonggi-do (KR)

(73) Assignee: SK hynix Inc., Icheon-si Gyeonggi-do (KR)

(21) Appl. No.: 15/696,963

(22) Filed: Sep. 6, 2017

(30) Foreign Application Priority Data
Jan. 18, 2017 (KR) 10-2017-0008518

(51) Int. Cl. G06F 13/28; G06F 3/06; G06F 13/16; G06F 13/40

(52) U.S. Cl. CPC G06F 13/28; G06F 3/0604; G06F 13/4081; G06F 3/0673; G06F 13/1689; G06F 3/0635

(57) ABSTRACT

A system may include a host and a hot plug module. The hot plug module may include a training memory for performing a training operation with the host. The hot plug module may include a control circuit configured to generate a path selection signal in response to a training command, and a signal gating circuit configured to couple a system signal bus to one of the memory module bus and the training memory, based on the path selection signal.

### CROSS-REFERENCES TO RELATED APPLICATION

The present application claims priority under 35 U.S.C. § 119(a) to Korean application number 10-2017-0008518, filed on Jan. 18, 2017, in the Korean Intellectual Property Office, which is incorporated herein by reference in its entirety.

### BACKGROUND

### 1. Technical Field

Various embodiments generally relate to a semiconductor technology, and more particularly, to a memory module and a system using the same.

### 2. Related Art

An electronic device may include many electronic components, and a large part of the electronic components may be implemented with a computer system semiconductor. A computer system as a representative electronic device generally includes a processor to perform the function of a host and a memory to perform a data storage function. In particular, the memory may include a plurality of memory devices mounted in the form of a module, and perform the function of a temporary memory device. Representative examples of a memory module may include DIMM (Dual In-line Memory Module). In general, DIMM may include a plurality of DRAMs mounted therein, and perform data communication with the processor through the plurality of DRAMs.

In order to newly connect the memory module for use or replace an existing memory module during operation of the computer system, the operation of the system needs to be stopped, and the system needs to be rebooted after the memory module is added or replaced. A general computer device can easily be rebooted, but a computer device such as a server cannot be easily rebooted. Therefore, research has recently been conducted on a solution to a hot plug method capable of adding and replacing a memory module without stopping the operation of a system.

### SUMMARY

In an embodiment, a system may include: a host; and a hot plug module coupled to the host and a memory module bus. The hot plug module may include: a training memory; a control circuit suitable for generating a path selection signal in response to a training command; and a signal gating circuit suitable for coupling a system signal bus to one of the memory module bus and the training memory, based on the path selection signal.

In an embodiment, a system may include: a host; a main board having a system signal bus coupled to the host and a memory module slot; and a hot plug module having a module pin mounted in the memory module slot and a secondary slot in which a memory module is mounted. The hot plug module may include: a training memory; a control circuit suitable for generating a path selection signal in response to a training command; and a signal gating circuit suitable for coupling the system signal bus to one of the secondary slot and the training memory, based on the path selection signal.

### BRIEF DESCRIPTION OF THE DRAWINGS

FIG. 1 is a diagram illustrating a configuration of a system in accordance with an embodiment.

FIGS. 2 and 3 are diagrams illustrating examples of the system in accordance with the present embodiment.

FIG. 4 is a diagram illustrating a configuration of a system in accordance with an embodiment.

### DETAILED DESCRIPTION

Hereinafter, a memory module and a system using the same will be described below with reference to the accompanying drawings through various example embodiments.

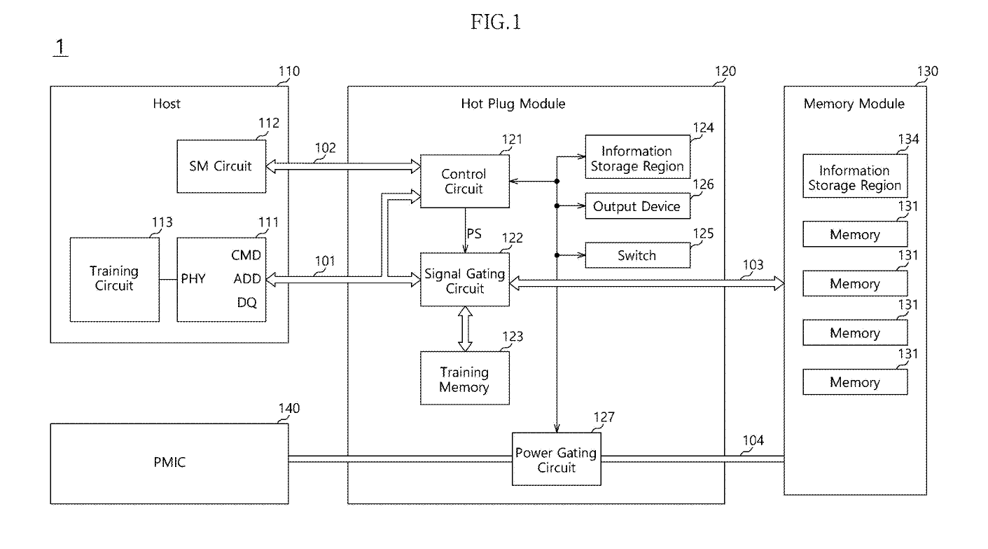

FIG. 1 is a diagram illustrating a configuration of a system 1 in accordance with an embodiment. In FIG. 1, the system 1 may include a host 110, a hot plug module 120, and a memory module 130. The host 110 may provide various control signals to the memory module 130 in order to control operation of the memory module 130. For example, the host 110 may transmit a command signal CMD, an address signal ADD, and data DQ through a system signal bus 101, and receive the data DQ through the system signal bus 101. The host 110 may be coupled to the hot plug module 120 through the system signal bus 101 and a system management bus 102. The host 110 may include a Central Processing Unit (CPU), Graphic Processing Unit (GPU), Multi-Media Processor (MMP), digital signal processor, or memory controller, which functions as a processor or controller. Furthermore, processor chips such as an Application Processor (AP), which have various functions, may be combined and implemented in the form of a System On Chip (SOC).

The hot plug module 120 may be coupled to the host 110 through the system signal bus 101 and the system management bus 102. The hot plug module 120 may be coupled to the memory module 130 through the memory module bus 103. The hot plug module 120 may relay communication between the host 110 and the memory module 130. For example, the hot plug module 120 may transmit a signal from the host 110 to the memory module 130, or transmit a signal from the memory module 130 to the host 110. The hot plug module 120 may perform a training operation with the host 110, when the memory module 130 is coupled or not coupled to the memory module bus 103. The hot plug module 120 may allow the memory module to be inserted or replaced anytime without stopping operation of the system. That is, the hot plug module 120 makes the hot plug operation possible.

The memory module 130 may be coupled to the hot plug module 120 through the memory module bus 103. The memory module 130 may store data DQ transmitted from the host 110 or output data stored in the memory module 130. An operation of the memory module 130 to store data transmitted from the host 110 may be referred to as a write operation, and an operation of the memory module 130 to transmit data stored in the memory module 130 to the host 110 may be referred to as a read operation. The memory module 130 may include a plurality of memory devices 131, and each of the memory devices 131 may include one or more of a volatile memory and a nonvolatile memory. The volatile memory may include Dynamic RAM (DRAM) and Synchronous DRAM (SDRAM), and the nonvolatile memory may include Read Only Memory (ROM), Programmable ROM (PROM), Electrically Erase and Programmable ROM (EEPROM), Electrically Programmable ROM (EPROM), Flash memory, Phase change RAM (PRAM), Magnetic RAM (MRAM), Resistive RAM (RRAM), Ferroelectric RAM (FRAM), and the like. The memory module 130 may include various types of memory modules such as Unbuffered Dual In-line Memory Module (UDIMM), Dual In-line Memory Module (DIMM), Registered Dual In-line Memory Module (RDIMM), Load Reduced Dual In-line Memory Module (LRDIMM), Small Outline Dual In-line Memory Module (SODIMM), and Non-Volatile Dual In-line Memory Module (NVDIMM).

In FIG. 1, the host 110 may include an interface circuit 111 and a system management circuit 112. The interface circuit 111 may be coupled to the control circuit 121 and the signal gating circuit 122 through the system signal bus 101. The interface circuit 111 may transmit the command signal CMD, the address signal ADD, and the data DQ to the hot plug module 120 through the system signal bus 101. The interface circuit 111 may receive the data DQ from the hot plug module 120 through the system signal bus 101. The system management circuit 112 may be coupled to the control circuit 121 of the hot plug module 120 through the system management bus 102. The system management circuit 112 may transmit/receive various system management signals to/from the hot plug module 120 through the system management bus 102, or receive various pieces of information concerning or on the hot plug module 120 or the memory module 130. The host 110 may further include a training circuit 113. The training circuit 113 may perform a training operation with the hot plug module 120 or the memory module 130. The training circuit 113 may generate a training request, and the interface circuit 111 may transmit a training command as the command signal CMD in response to the training request. The training circuit 113 may receive and store training information which is generated as a result of the training operation with the hot plug module 120 or the memory module 130.

The hot plug module 120 may include a control circuit 121, a signal gating circuit 122, and a training memory 123. The control circuit 121 may be coupled to the system signal bus 101, the system management bus 102, and the signal gating circuit 122. The control circuit 121 may generate a path selection signal PS depending on whether a memory module coupled to the memory module bus 103 is present. For example, the control circuit 121 may disable the path selection signal PS when a memory module coupled to the hot plug module 120 via the memory module bus 103 is present, or enable the path selection signal PS when a memory module coupled to the hot plug module 120 via the memory module bus 103 is not present. The control circuit 121 may generate the path selection signal PS in response to the training command. The training command may be transmitted as the command signal CMD to the control circuit 121 according to control of the training circuit 113. For example, the control circuit 121 may enable the path selection signal PS when receiving the training command, and disable the path selection signal PS when the training operation is completed.

The signal gating circuit 122 may be coupled to the system signal bus 101 and the memory module bus 103. The signal gating circuit 122 may couple the system signal bus 101 to one of the training memory 123 and the memory module bus 103, based on the path selection signal PS. Thus, the signal gating circuit 122 may couple one of the memory module bus 103 and the training memory 123 to the host 110, based on the path selection signal PS. The training memory 123 may be coupled to the signal gating circuit 122 and perform a training operation. The training memory 123 may be implemented with a memory device having a minimum number of components and a minimum capacity to perform the training operation. For example, the training memory 123 may have a smaller capacity than the memory devices 131 constituting the memory module 130. The training operation between the host 110 and the training memory 123 may be performed in various manners. For example, the host 110 may perform a training operation with the training memory 123, in order to adjust a skew depending on the position of the hot plug module 120 or the memory module 130 mounted in the system 1. For example, the training operation to adjust a skew may include one or more of a command/clock training, a data training, a data strobe signal training, a reference voltage training, a write leveling, a write fly by, a round trip optimization, a receive enable, a transmission equalization, a Continuous time Linear Equalization, and so on.

The hot plug module 120 and the memory module 130 may include information storage regions 124 and 134, respectively. The information storage regions 124 and 134 may be implemented with Electrically Erasable and Programmable Read Only Memory (EEPROM) that stores Serial Presence Detect (SPD) information. The information storage regions 124 and 134 may store various pieces of information concerning the memory module 130, such as the capacity and operating speed of the memory module 130. The information storage regions 124 and 134 may store various pieces of information concerning the memory module 130 coupled to the hot plug module 120 via the memory module bus 103. The various pieces of information stored in the information storage regions 124 and 134 may be transmitted by the control circuit 121 to the host 110 through the system management bus 102. When receiving the various pieces of information from both of the information storage regions 124 and 134 of the hot plug module 120 and the memory module 130, the host 110 may sense that the memory module 130 coupled to the memory module bus 103 is present. When receiving the various pieces of information only from the information storage region 124 of the hot plug module 120, the host 110 may sense that the memory module 130 coupled to the memory module bus 103 is not present.

The hot plug module 120 may further include a switch 125 and an output device 126. When the memory module bus 103 and the memory module 130 are coupled to each other or the memory module 130 coupled to the memory module bus 103 is replaced, the switch 125 may receive a user's input. The switch 125 may sense the user's input, and inform the control circuit 121 of the user's input. The user's input may be provided in a physical or program manner. For example, the user may physically operate the switch 125 to inform the control circuit 121 of the connection or replacement of the memory module 130. Also, the user may execute a program which can be executed through the system 1, and inform the control circuit 121 of the connection or replacement of the memory module 130. The output device 126 may output various displays depending on the operation state of the system 1. The output device 126 may include a display device such as an LED device, which can be identified by a user with the naked eye. The output device 126 may display various colors depending on the operation state of the system 1. The control circuit 121 may transmit an interrupt request to the host 110 when the user's input is received through the switch 125. The interrupt request may be transmitted as a system management signal through the system management bus 102. When the hot plug operation is completed, the control circuit 121 may transmit a completion signal to the host 110, and change the state of the output device 126. The completion signal may be transmitted as the system management signal to the host 110 through the system management bus 102. The host 110 may perform a data backup operation, which includes backing up data stored in the memory module 130 coupled to the memory module bus 103, when receiving the interrupt request from the control circuit 121. The host 110 may provide the command signal CMD and the address signal ADD based on the interrupt request, in order to perform the data backup operation.

The hot plug module may further include a power gating circuit 127. The power gating circuit 127 may provide a supply voltage to a memory module power line 104 based on a power control signal generated from the control circuit 121. The system 1 may further include a power management circuit (PMIC) 140 to provide the supply voltage to the power gating circuit 127. For example, when the power control signal is enabled, the power gating circuit 127 does not provide the supply voltage to the memory module power line 104. That is, when the power control signal is enabled, the connection between the power gating circuit 127 and the memory module power line 104 may be blocked. When the power control signal is disabled, the power gating circuit 127 may provide the supply voltage to the memory module power line 104. The control circuit 121 may generate the power control signal with the interrupt request. The control circuit 121 may enable the power control signal while generating the interrupt request. The control circuit 121 may disable the power control signal while generating the completion signal. The power gating circuit 127 may block supply of the supply voltage to the memory module power line 104 during the hot plug operation.

1) Training operation and hot plug operation, when hot plug module is coupled and memory module is not coupled

When the memory module bus 103 and the memory module 130 are not coupled, a training operation may be performed between the host 110 and the hot plug module 120. The host 110 may transmit the training command as the command signal CMD to the system signal bus 101 in response to the training request generated from the training circuit 113. The control circuit 121 may enable the path selection signal PS in response to the training command. When the path selection signal PS is enabled, the signal gating circuit 122 may couple the host 110 via the system signal bus 101 to the training memory 123. The host 110 may transmit the command signal CMD, the address signal ADD, and the data DQ to perform the training operation with the training memory 123, and the training memory 123 may transmit the training information as the data DQ to the host 110. The training circuit 113 may receive and store the training information transmitted from the hot plug module 120.

Then, when the memory module 130 is coupled to the memory module bus 103, the training circuit 113 does not need to perform a training operation with the memory module 130 coupled to the memory module bus 103, because the training circuit 113 stores the training information. Thus, although the memory module 130 is coupled to the memory module bus 103, the system 1 does not need to be rebooted, but can immediately perform a normal operation. The control circuit 121 may generate an interrupt request in response to a user input received through the switch 125. The host 110 may receive the interrupt request through the system management bus 102, and transmit no signals through the system signal bus 101. When the memory module 130 is coupled to the memory module bus 103, various pieces of information stored in the information storage region 134 of the memory module 130 may be transmitted to the control circuit 121. The control circuit 121 may transmit the various pieces of information received from the memory module 130 to the host 110 through the system management bus 102, and generate the completion signal. The control circuit 121 may disable the path selection signal PS based on the completion signal. The signal gating circuit 122 may couple the host 110 via the system signal bus 101 to the memory module bus 103 when the path selection signal PS is disabled. The control circuit 121 may disable a power control signal based on the completion signal, and the power gating circuit 127 may provide the supply voltage to the memory module 130 through the memory module power line 104. The control circuit 121 may control the output device 126 to inform the user that the memory module 130 was coupled, based on the completion signal.

2) Training operation and hot plug operation, when both of hot plug module and memory module are coupled

When the host 110 is coupled to both of the hot plug module 120 and the memory module 130, the host 110 may perform a training operation with at least one of the hot plug module 120 and the memory module 130. The host 110 may preferentially perform a training operation with the hot plug module 120, or preferentially perform a training operation with the memory module 130. When the training operation is completed, the training information may be stored in the training circuit 113.

The hot plug module 120 may allow the memory module 130 to be replaced, even though the system 1 is not rebooted. When the user replaces the memory module 130, the control circuit 121 may receive a user input through the switch 125, and generate an interrupt request. The control circuit 121 may control the output device 126 to inform the user that the memory module 130 is being ready to be replaced, based on the interrupt request. The control circuit 121 may provide the interrupt request to the host 110, and the host 110 may read data stored in the memory module 130 and back up the data stored in the memory module 130. When the backup of the data stored in the memory module 130 is completed, the host 110 may transmit a backup completion signal to the control circuit 121 through the system management bus 102 or the system signal bus 101. The control circuit 121 may enable the power control signal based on the backup completion signal, and the power gating circuit 127 may block the supply of the supply voltage to the memory module power line 104. Furthermore, the control circuit 121 may control the output device 126 to inform the user that the memory module 130 can be replaced, based on the backup completion signal. The user may check the output device 126, remove the memory module 130 coupled to the memory module bus 103, and couple a new memory module to the memory module bus 103 in place of the memory module 130.

When the new memory module is coupled to the memory module bus 103, various pieces of information stored in the information storage region of the new memory module may be transmitted to the control circuit 121. The control circuit 121 may transmit the various pieces of information received from the new memory module to the host 110 through the system management bus 102, and generate a completion signal. Further, the host 110 may store data in the new memory module coupled to the memory module bus 103. The control circuit 121 may disable the power control signal based on the completion signal, and the power gating circuit 127 may provide the supply voltage to the memory module 130 through the memory module power line 104. The control circuit 121 may control the output device 126 to inform the user that the new memory module is normally coupled, based on the completion signal.

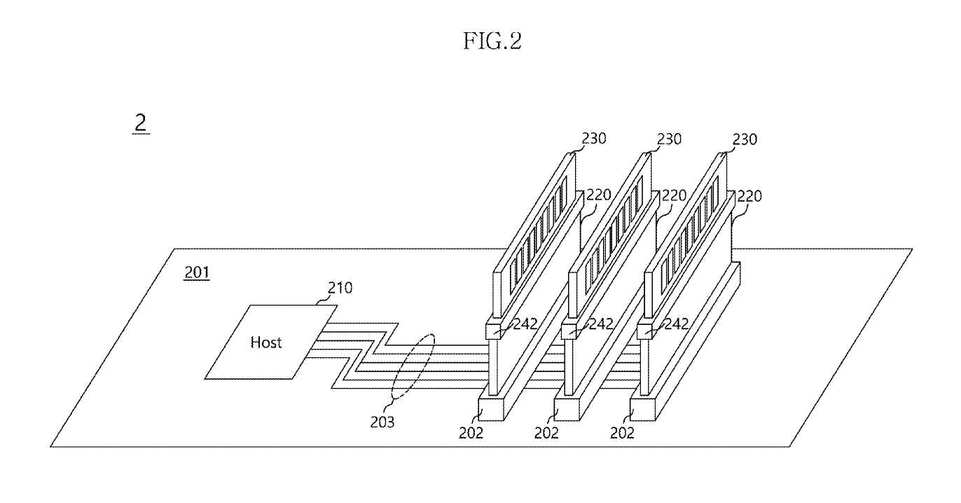

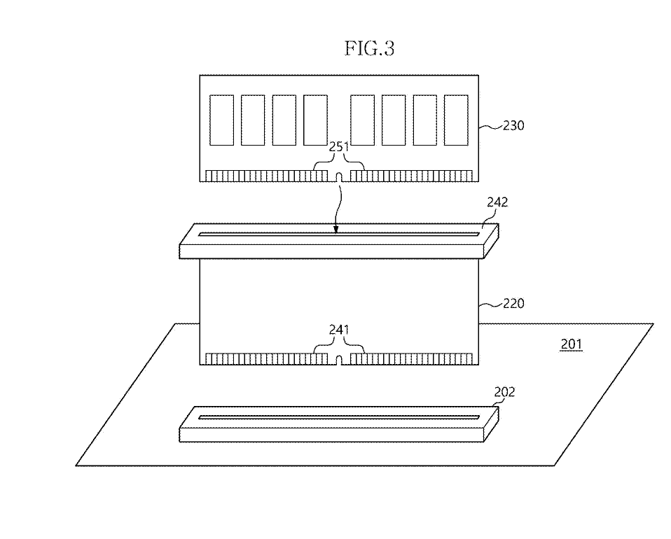

FIGS. 2 and 3 are diagrams illustrating examples of a system 2 in accordance with an embodiment. The system 2 may include a main board 201, a host 210, a hot plug module 220, and a memory module 230. The main board 201 for mounting components constituting the system 2 may also be referred to as a mother board. The main board 201 may include a slot (not illustrated) in which the host 210 can be mounted and a module slot 202 in which the memory module 230 or the hot plug module 220 can be mounted. The main board 201 may include wirings 203 for electrically coupling the host 210 to the hot plug module 220 and/or the memory module 230. The wirings 203 may include the system signal bus 101 and the system management bus 102 which are illustrated in FIG. 1. The host 210 may be mounted on the main board 201.

In general, the memory module 230 may be mounted on the main board 201 through the module slot 202 of the main board 201. In the present embodiment, the hot plug module 220 may be mounted on the main board 201 through the module slot 202, instead of the memory module 230. The memory module 230 may be mounted on the hot plug module 220. Referring to FIG. 3, the hot plug module 220 may have a module pin 241 installed at one side of the hot plug module 220. The hot plug module 220 may be mounted in the module slot 202 installed on the main board 201. The module pin 241 of the hot plug module 220 may be coupled to a pin formed in the module slot 202, and coupled to the system signal bus 101 and the system management bus 102. The hot plug module 220 may have a secondary slot 242 installed at the other side of the hot plug module 220. The secondary slot 242 may be provided as the memory module bus 103. The memory module 230 may include a module pin 251 so as to be mounted in the secondary slot 242. A module pin 251 of the memory module 230 may be coupled to a pin formed in the secondary slot 242, and couple the memory module 230 and the memory module bus 103. Further, the signal gating circuit 122 of the hot plug module 220 may couple the system signal bus 101 to one of the secondary slot 242 and the training memory 123 based on the path selection signal PS.

The hot plug module 220 may be mounted only in some of the plurality of module slots 202. The memory module 230 may be mounted on the hot plug module 220 or not mounted on the hot plug module 220. The hot plug module 220 may perform a training operation with the host 210 even though the memory module 230 is not mounted, and the host 210 may store training information transmitted through the hot plug module 220. Thus, when a user wants to connect the memory module 230 to the secondary slot 242 of the hot plug module 220 on which the memory module 230 is not mounted, the memory module 230 can be coupled without rebooting the system 2 during the operation of the system 2. That is, the hot plug operation can be performed. Furthermore, although the memory module 230 is already mounted on the hot plug module 220, the user can replace the mounted memory module 230 with a new memory module during operation of the system 2.

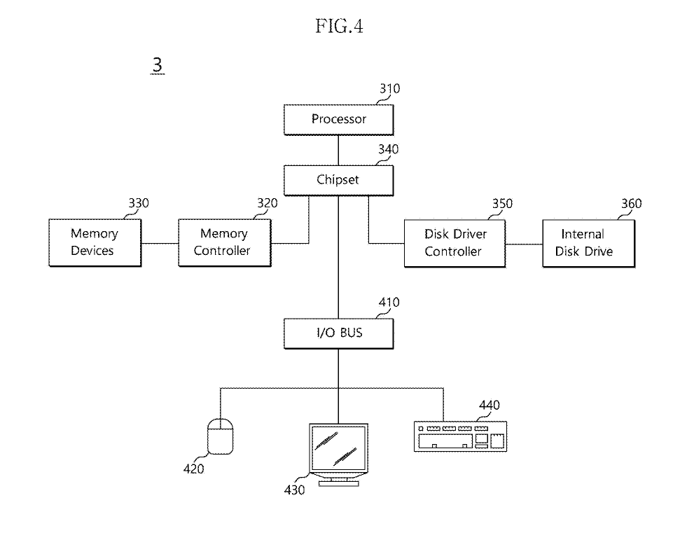

FIG. 4 is a diagram illustrating a configuration of a system 3 in accordance with an embodiment. In FIG. 4, the system 3 may include a processor 310, a memory controller 320 and a memory device 330. The processor 310 may be coupled to the memory controller 320 through a chip set 340, and the memory controller 320 may be coupled to the memory device 330 through a plurality of buses. FIG. 4 illustrates one processor 310. However, the present embodiment is not limited thereto, but the system may include a plurality of physical or logical processors. The chip set 340 may provide a communication path through which a signal is transmitted between the processor 310 and the memory controller 320. The processor 310 may perform an arithmetic operation, and transmit a request and data to the memory controller 320 through the chip set 340 in order to input/output desired data.

The memory controller 320 may transmit a command signal, address signal, clock signal and data through the plurality of buses. The memory device 330 may store data by receiving the signals from the memory controller 320, and output the stored data to the memory controller 320. The memory device 330 may include one or more memory devices or memory modules, and the hot plug module 120 of FIG. 1 may be used in the memory device 330.

In FIG. 4, the system 3 may further include an input/output bus 410, an input/output device 420, 430, or 440, a disk driver controller 350 and a disk drive 360. The chip set 340 may be coupled to the input/output bus 410. The input/output bus 410 may provide a communication path for signal transmission from the chip set 340 to the input/output device 420, 430, or 440. The input/output device may include a mouse 420, a video display 430, or a keyboard 440. The input/output bus 410 may include any communication protocols as long as the communication protocols can communicate with the input/output device 420, 430, or 440. The input/output bus 410 may be integrated in the chip set 340.

The disk driver controller 350 may be coupled to the chip set 340. The disk driver controller 350 may provide a communication path between the chip set 340 and one or more disk drives 360. The disk drive 360 may be utilized as an external data storage device for storing a command and data. The disk driver controller 350 and the disk drive 360 may communicate with each other or the chip set 340 through any communication protocols including the input/output bus 410.

While various embodiments have been described above, it will be understood to those skilled in the art that the embodiments described are examples only. Accordingly, the operating method of a data storage device described herein should not be limited based on the described embodiments.

What is claimed is:

1. A system comprising:
a host; and
a hot plug module coupled to the host and a memory module bus,
wherein the hot plug module comprises:
a training memory;
a control circuit configured to generate a path selection signal in response to a training command; and
a signal gating circuit configured to couple a system signal bus to one of the memory module bus and the training memory, based on the path selection signal.

2. The system of claim 1, wherein the hot plug module transmits training information to the host, and the host stores the training information.

3. The system of claim 1, wherein the control circuit disables the path selection signal when a memory module coupled to the memory module bus is present, and enables the path selection signal when a memory module coupled to the memory module bus is not present or the training command is received.

4. The system of claim 3, wherein the signal gating circuit couples the host and the training memory when the path selection signal is enabled, and couples the host and the memory module bus when the path selection signal is disabled.

5. The system of claim 1, wherein the hot plug module further comprises an information storage region for storing information on a memory module which is coupled to the memory module bus, and the control circuit provides the information stored in the information storage region to the host.

6. The system of claim 1, wherein the hot plug module further comprises:
a switch configured to receive a user's input when the memory module bus is coupled to a memory module or the memory module coupled to the memory module bus is replaced; and
an output device controlled by the control circuit and configured to display the operation state of the system.

7. The system of claim 1, wherein the control circuit transmits an interrupt request to the host when a user's input is received, and outputs a completion signal to the host when the hot plug operation is completed.

8. The system of claim 7, wherein the host backs up data stored in a memory module coupled to the memory module bus in response to the interrupt request, and stores the data in a new memory module coupled to the memory module bus.

9. The system of claim 1, wherein the hot plug module comprises a power gating circuit configured to receive a supply voltage from a power management circuit, and provide the supply voltage to a memory module power line based on a power control signal.

10. The system of claim 9, wherein the power gating circuit does not provide the supply voltage to the memory module power line when the power control signal is enabled, and provides the supply voltage to the memory module power line when the power control signal is disabled.

11. The system of claim 1, wherein the host comprises:
a system management circuit coupled to the control circuit through a system management bus;
an interface circuit coupled to the control circuit and the signal gating circuit through the system signal bus; and
a training circuit suitable for generating a training request, and storing training information.

12. A system comprising:
a host;
a main board having a system signal bus coupled to the host and a memory module slot; and
a hot plug module having a module pin mounted in the memory module slot and a secondary slot in which a memory module is mounted,
wherein the hot plug module comprises:
a training memory;
a control circuit configured to generate a path selection signal in response to a training command; and
a signal gating circuit configured to couple the system signal bus to one of the secondary slot and the training memory, based on the path selection signal.

13. The system of claim 12, wherein the hot plug module transmits training information to the host, and the host stores the training information.

14. The system of claim 12, wherein the control circuit generates the path selection signal based on the training command or whether a memory module coupled to a memory module bus is present.

15. The system of claim 12, wherein the control circuit transmits an interrupt request to the host when a user's input is received, and outputs a completion signal to the host when the hot plug operation is completed.

16. The system of claim 15, wherein the host backs up data stored in a memory module coupled to the memory module bus in response to the interrupt request, and stores the data in a new memory module coupled to the memory module bus.

17. The system of claim 12, wherein the hot plug module comprises a power gating circuit configured to receive a supply voltage from a power management circuit, and provide the supply voltage to a memory module power line based on a power control signal.

18. The system of claim 12, wherein the host is configured to perform a training operation with at least one of the hot plug module and the memory module when the host is coupled to both the hot plug module and the memory module.

19. The system of claim 18, wherein the host performs the training operation to adjust a skew depending on a position of at least one of the memory module and the hot plug module.
